(19) United States
(12) Patent Application Publication
(10) Pub. No.: US 2024/0394486 A1
(43) Pub. Date: Nov. 28, 2024

(54) FOREIGN OBJECT DETECTION DEVICE AND FOREIGN OBJECT DETECTION METHOD

(71) Applicant: TOSHIBA TEC KABUSHIKI KAISHA, Tokyo (JP)

(72) Inventors: Yohei Yanase, Kita Tokyo (JP); Shoichi Katoh, Suita Osaka (JP); Tihiro Tanaka, Kawasaki Kanagawa (JP); Yasuhiro Nakajima, Izunokuni Shizuoka (JP)

(21) Appl. No.: 18/534,767

(22) Filed: Dec. 11, 2023

(30) Foreign Application Priority Data
Mar. 27, 2023 (JP) 2023-050499

(51) Int. Cl. G06K 7/10; G06K 19/07

(52) U.S. Cl. CPC G06K 7/10009; G06K 19/0723

(57) ABSTRACT

According to one embodiment, detection of a foreign object mixed in a container can be efficiently performed. A foreign object detection device includes: a determination unit configured to determine, based on a reading result of a wireless tag obtained by radiating a radio wave for reading the wireless tag for a container housing an article and a data file in which a tag identifier held by a wireless tag attached to a foreign object different from the article is registered, whether the wireless tag attached to the foreign object is read; and a notification unit configured to notify that the foreign object is detected if it is determined that the wireless tag attached to the foreign object is read.

### CROSS-REFERENCE TO RELATED APPLICATION

This application is based upon and claims the benefit of priority from Japanese Patent Application No. 2023-050499, filed Mar. 27, 2023, the entire contents of which are incorporated herein by reference.

### FIELD

Embodiments described herein relate generally to a foreign object detection device and a foreign object detection method.

### BACKGROUND

In the related art, a wireless tag is attached to an article to be subjected to distribution, and inventory management or the like of merchandise is performed by reading data stored in the wireless tag. In reading of the wireless tag, for example, a reader and writer device using short range wireless communication such as radio frequency identification (RFID) is used.

At a site such as a distribution warehouse, equipment such as scissors may be used for packaging of articles. At such a site, there is a possibility that a mistake may occur in which a container is shipped with equipment mixed in the container that houses the articles. Therefore, there is a demand for a technique capable of efficiently detecting the equipment mixed in the container.

### DESCRIPTION OF THE DRAWINGS

FIG. 1 is a diagram illustrating an example of a configuration of a foreign object detection system according to an embodiment;

FIG. 2A is a diagram illustrating an example of an appearance of a wireless tag reading device from a front side and FIG. 2B is a diagram illustrating an example of an appearance of a wireless tag reading device from a back side;

FIG. 3 is a diagram illustrating an example of a hardware configuration;

FIG. 4 is a diagram illustrating an example of a hardware configuration of a mobile terminal;

FIG. 5 is a diagram illustrating an example of a data configuration of an equipment master;

FIG. 6 is a diagram illustrating an example of a functional configuration of the wireless tag reading device and the mobile terminal;

FIG. 7 is a diagram illustrating an example of a GUI displayed on a display unit;

FIG. 8 is a diagram illustrating an example of the GUI;

FIG. 9 is a diagram illustrating an example of the GUI;

FIG. 10 is a diagram illustrating an example of the GUI;

FIG. 11 is a diagram illustrating an example of the GUI;

FIG. 12 is a diagram illustrating an example of the GUI;

FIG. 13 is a diagram illustrating an example of the GUI;

FIG. 14 is a diagram illustrating an example of the GUI;

FIG. 15 is a flowchart illustrating an example of foreign object detection processing executing by the mobile terminal;

FIG. 16 is a flowchart illustrating an example of search processing; and

FIG. 17 is a flowchart illustrating an example of stock processing.

### DETAILED DESCRIPTION

An embodiment is to be efficiently capable of detecting, a foreign object mixed in a container.

In general, according to one embodiment, a foreign object detection device includes a determination unit and a notification unit. The determination unit is configured to determine, based on a reading result of a wireless tag obtained by radiating a radio wave for reading the wireless tag for a container housing an article and a data file in which a tag identifier held by a wireless tag attached to a foreign object different from the article is registered, whether the wireless tag attached to the foreign object is read. The notification unit is configured to notify that the foreign object is detected if it is determined that the wireless tag attached to the foreign object is read.

Hereinafter, a foreign object detection device and a foreign object detection method according to the embodiment will be described with reference to the drawings. In the present embodiment, an example will be described in which the foreign object detection device is applied to a foreign object detection system that detects a foreign object mixed in a container that houses an article to be distributed in a distribution site such as a warehouse. The present disclosure is not limited to the embodiment described below.

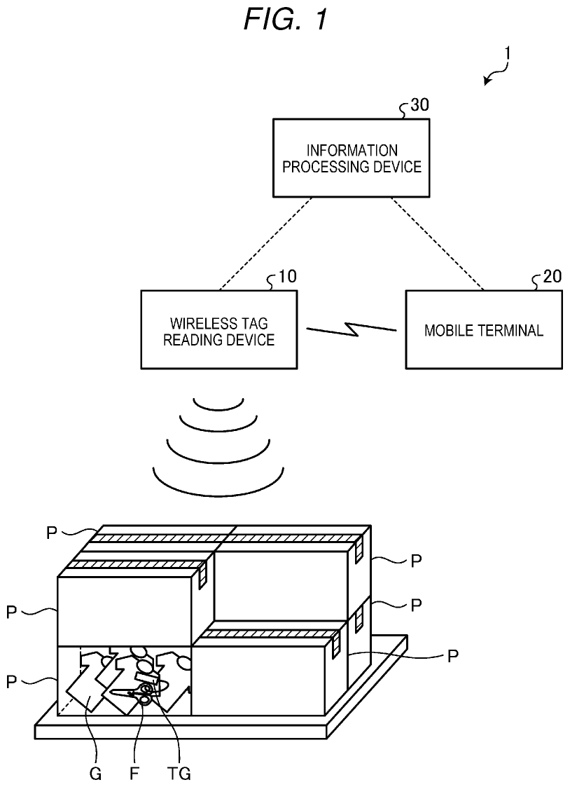

FIG. 1 is a diagram illustrating an example of a configuration of the foreign object detection system according to the present embodiment. As illustrated in FIG. 1, a foreign object detection system 1 includes a wireless tag reading device 10, a mobile terminal 20, and an information processing device 30.

The wireless tag reading device 10 is an example of a reading unit. The wireless tag reading device 10 is a reader and writer device capable of reading tag data stored in a wireless tag TG in a non-contact manner. The wireless tag TG is a passive wireless tag such as a radio frequency identification (RFID) tag.

In the present embodiment, the wireless tag TG is attached to respective equipment F used in a distribution site such as a distribution warehouse, and stores tag data in a storage medium (not illustrated). The tag data includes a tag identifier or the like capable of identifying the wireless tag TG itself. When the wireless tag reading device 10 reads the tag data from the wireless tag TG, the wireless tag reading device 10 outputs the tag data to an external device such as the mobile terminal 20 connected to the wireless tag reading device 10 thereof.

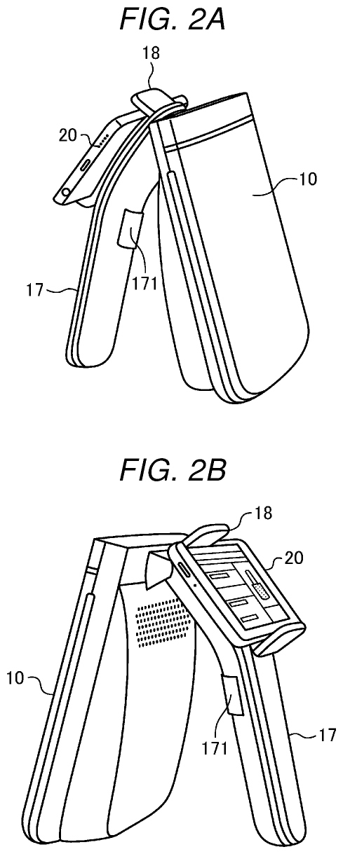

FIGS. 2A/2B are diagrams illustrating an example of an appearance of the wireless tag reading device 10. FIG. 2A illustrates a state viewed from a front side (a side facing merchandise), and FIG. 2B illustrates a state viewed from a rear side (a side facing an operator). The wireless tag reading device 10 according to the present embodiment is a handy type wireless tag reading device as illustrated in FIGS. 2A/2B, and can be carried by the operator. During carrying, the operator can use a handle 17 provided on a rear surface of the wireless tag reading device 10 as a handle grip. The handle 17 is provided with a trigger button 171 that can be operated while gripping the handle 17. In addition, the wireless tag reading device 10 is provided with an attachment unit 18 for detachably attaching the mobile terminal 20.

As illustrated in FIG. 1, the wireless tag reading device 10 is directed toward a container P and is used to detect a foreign object mixed in the container P. Here, the container P is, for example, a container or a cardboard box, and houses an article G to be distributed. The foreign object is an article, which is not to be distributed, mixed when the article G is housed. In the present embodiment, an equipment F such as scissors or a cutter used in the distribution site is detected as a foreign object.

The mobile terminal 20 is an example of a foreign object detection device. The mobile terminal 20 is a portable terminal device such as a smartphone or a tablet terminal. The mobile terminal 20 is communicably connected to the wireless tag reading device 10 by wireless connection such as Bluetooth (registered trademark) or wired connection. The mobile terminal 20 can also be connected to the information processing device 30 by wired connection or wireless connection.

The mobile terminal 20 controls a reading operation on a wireless tag performed by the wireless tag reading device 10. In addition, the mobile terminal 20 receives tag data transmitted from the wireless tag reading device 10, and detects, based on the tag data, a foreign object mixed in the container.

As illustrated in FIG. 1, the mobile terminal 20 according to the present embodiment is separated from the wireless tag reading device 10. As illustrated in FIGS. 2A/2B, the mobile terminal 20 can be detachably attached to the wireless tag reading device 10 via the attachment unit 18 provided on the wireless tag reading device 10. Configurations of the wireless tag reading device 10 and the mobile terminal 20 are not limited thereto, and the wireless tag reading device 10 and the mobile terminal 20 may be integrally configured.

The information processing device 30 is an information processing device such as a personal computer (PC). The information processing device 30 can be connected to the wireless tag reading device 10 and the mobile terminal 20 by wireless connection or wired connection.

In the present embodiment, the information processing device 30 generates and manages a data file for foreign object detection (hereinafter, also referred to as an equipment master) by using the wireless tag reading device 10. For example, the information processing device 30 acquires, by using the wireless tag reading device 10, a tag identifier of the wireless tag TG from a respective one piece of the equipment F used at the distribution site, generates an equipment master in which the acquired tag identifier is associated with information on the equipment F, and stores the equipment master in the storage medium (not illustrated). In addition, the information processing device 30 is used for the foreign object detection or the like by transmitting the generated equipment master to the mobile terminal 20. Data configuration of the equipment master will be described later.

Next, hardware configurations of the wireless tag reading device 10 and the mobile terminal 20 will be described.

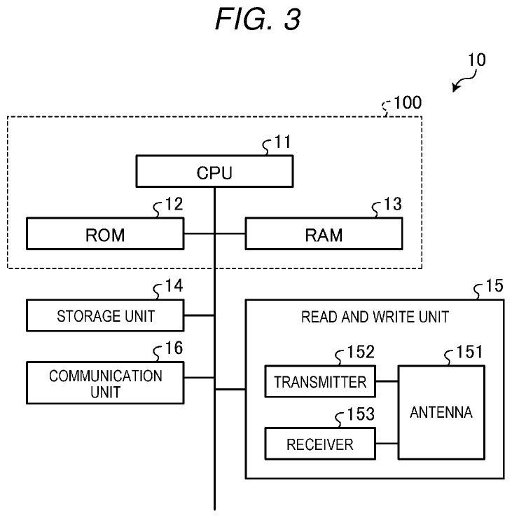

FIG. 3 is a diagram illustrating an example of the hardware configuration of the wireless tag reading device 10. As illustrated in FIG. 3, the wireless tag reading device 10 includes a central processing unit (CPU) 11, a read only memory (ROM) 12, a random access memory (RAM) 13, a storage unit 14, and the like. The CPU 11 is an example of a processor and integrally controls an operation of the wireless tag reading device 10. The ROM 12 stores various programs. The RAM 13 is used as a working memory for loading various types of data.

The CPU 11, the ROM 12, the RAM 13, and the storage unit 14 are connected to one another via a bus or the like. Here, the CPU 11, the ROM 12, and the RAM 13 constitute a control unit 100. The control unit 100 executes various types of control processing when the CPU 11 operates according to the programs stored in the ROM 12 and the storage unit 14.

The storage unit 14 is implemented by a nonvolatile memory such as a flash memory that holds stored information even if the power is turned off. The storage unit 14 stores various programs and setting information.

A read and write unit 15 and a communication unit 16 are connected to the control unit 100 via the bus or the like. The read and write unit 15 includes an antenna 151, a transmitter 152, and a receiver 153.

The antenna 151 transmits and receives a radio wave communicable with the wireless tag TG. The transmitter 152 supplies the antenna 151 with electric power that causes the antenna 151 to radiate the radio wave. The receiver 153 receives the radio wave transmitted from the wireless tag TG via the antenna 151.

Under the control of the control unit 100, the read and write unit 15 radiates a radio wave for reading the wireless tag TG and receives a radio wave radiated by the wireless tag that receives the radio wave, thereby reading the tag data stored in the wireless tag TG. In addition, under the control of the control unit 100, the read and write unit 15 can also write data into the storage medium of the wireless tag TG by radiating a radio wave for writing data into the wireless tag TG.

The communication unit 16 is a communication interface for connecting the mobile terminal 20 to the information processing device 30. For example, the communication unit 16 is a communication interface conforming to a wireless communication standard such as Bluetooth (registered trademark). In addition, for example, the communication unit 16 is a communication interface conforming to a communication plan such as a universal serial bus (USB).

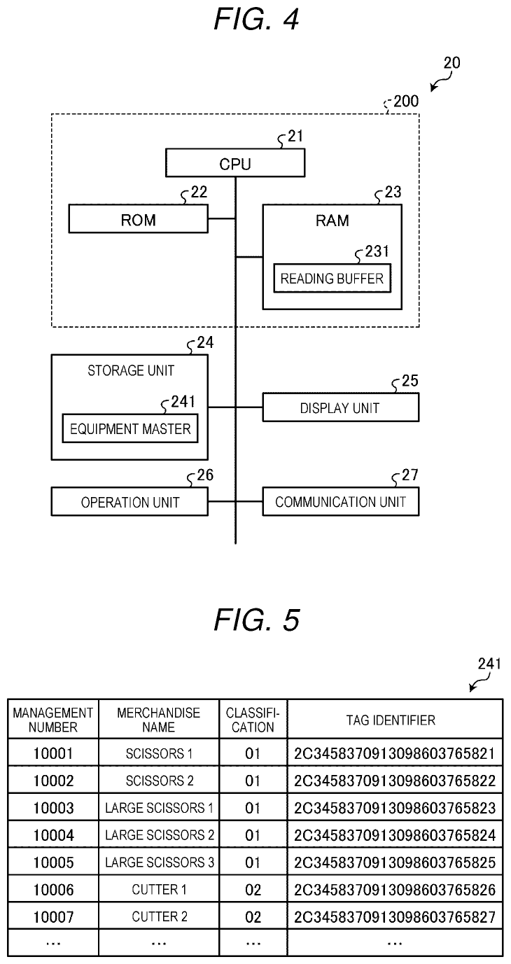

FIG. 4 is a diagram illustrating an example of the hardware configuration of the mobile terminal 20. As illustrated in FIG. 4, the mobile terminal 20 includes a CPU 21, a ROM 22, a RAM 23, a storage unit 24, and the like.

The CPU 21 is an example of a processor, and integrally controls an operation of the mobile terminal 20. The ROM 22 stores various programs. The RAM 23 is used as a working memory for loading various types of data. In addition, the RAM 23 holds a reading buffer 231 for storing (hereinafter, also referred to as registration) the tag data read by the wireless tag reading device 10.

The CPU 21, the ROM 22, the RAM 23, and the storage unit 24 are connected to one another via the bus or the like. Here, the CPU 21, the ROM 22, and the RAM 23 constitute a control unit 200. A display unit 25, an operation unit 26, a communication unit 27, or the like are connected to the control unit 200 via the bus or the like. When the CPU 21 operates according to the programs stored in the ROM 22 and the storage unit 24, the control unit 200 executes various types of control processing for integrally controlling the above-described units (the display unit 25, the operation unit 26, the communication unit 27, or the like).

The storage unit 24 is implemented by a nonvolatile memory such as a flash memory that holds stored information even if the power is turned off. The storage unit 24 stores various programs and setting information.

For example, the storage unit 24 stores an application program for controlling the wireless tag reading device 10. When the CPU 21 executes the application program, a graphic user interface (GUI) for operating the wireless tag reading device 10 is displayed on the display unit 25.

The storage unit 24 stores an equipment master 241. FIG. 5 is a diagram illustrating an example of a data configuration of the equipment master 241. As illustrated in FIG. 5, the equipment master 241 stores a management number, a merchandise name, a classification, and a tag identifier in association with one another.

The management number is unique information, which is assigned to a respective one piece of the equipment F, for managing the equipment F. The merchandise name is information indicating a merchandise name of the equipment F. FIG. 5 illustrates an example in which a unique merchandise name is assigned to a respective one piece of the equipment F. The classification is information indicating a classification to which the equipment F belongs. For example, a character string and a classification code indicating scissors as a classification is stored in the equipment F in the scissors classification. FIG. 5 illustrates an example in which the classification code is stored as the classification. The tag identifier stored in the wireless tag TG attached to the equipment F is stored in the tag identifier.

The data configuration of the equipment master 241 is not limited to the example of FIG. 5. For example, the equipment master 241 may store the number of pieces of equipment F belonging to each classification.

Referring back to FIG. 4, the display unit 25 is formed of, for example, a liquid crystal panel, and displays various types of information to the operator. The operation unit 26 includes input devices such as various operation buttons and a touch panel, and receives operations by the operator. The touch panel is provided to overlap the display unit 25, and receives an operation corresponding to a display content (GUI) of the display unit 25. The communication unit 27 is a communication interface conforming to the same communication standard as that of the communication unit 16 described above. The communication unit 27 communicates with the wireless tag reading device 10 and the information processing device 30.

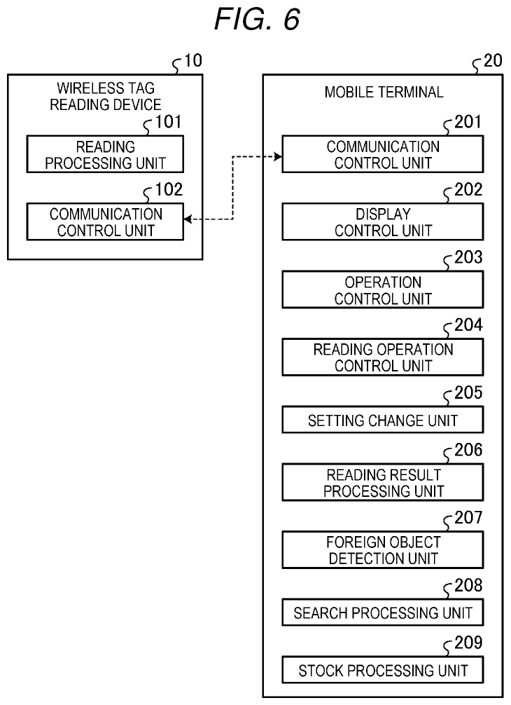

Next, functional configurations of the wireless tag reading device 10 and the mobile terminal 20 will be described. FIG. 6 is a diagram illustrating an example of the functional configurations of the wireless tag reading device 10 and the mobile terminal 20.

As illustrated in FIG. 6, the wireless tag reading device 10 includes a reading processing unit 101 and a communication control unit 102 as the functional configurations.

A part or all of the functional configuration of the wireless tag reading device 10 may be a software configuration implemented by cooperation between a processor (for example, the CPU 11) of the wireless tag reading device 10 and a program stored in a memory (for example, the ROM 12 and the storage unit 14). A part or all of the functional configuration of the wireless tag reading device 10 may be a hardware configuration implemented by a dedicated circuit or the like mounted on the wireless tag reading device 10.

On the other hand, as illustrated in FIG. 6, the mobile terminal 20 includes a communication control unit 201, a display control unit 202, an operation control unit 203, a reading operation control unit 204, a setting change unit 205, a reading result processing unit 206, a foreign object detection unit 207, a search processing unit 208, and a stock processing unit 209 as the functional configurations.

A part or all of the functional configuration of the mobile terminal 20 may be a software configuration implemented by cooperation between a processor (for example, the CPU 21) of the mobile terminal 20 and a program stored in a memory (for example, the ROM 22 and the storage unit 24). A part or all of the functional configuration of the mobile terminal 20 may be a hardware configuration implemented by a dedicated circuit or the like mounted on the mobile terminal 20.

The reading processing unit 101 reads the tag data from the wireless tag TG in cooperation with the read and write unit 15. Specifically, the reading processing unit 101 reads the tag data from the wireless tag TG in a communication region of the antenna 151 based on an instruction from the mobile terminal 20. In addition, if tag identification is designated from the mobile terminal 20, the reading processing unit 101 reads the tag data including the tag identification.

The communication control unit 102 controls communication with the mobile terminal 20 in cooperation with the communication unit 16. Specifically, the communication control unit 102 transmits the tag data read by the reading processing unit 101 to the mobile terminal 20. In addition, the communication control unit 102 receives various types of information (such as an operation instruction to be described later) transmitted from the mobile terminal 20.

The communication control unit 201 controls communication with the wireless tag reading device 10 in cooperation with the communication unit 27. Specifically, the communication control unit 201 transmits, to the wireless tag reading device 10, instruction information for instructing the operation of the wireless tag reading device 10 such as start and end of reading output by the reading operation control unit 204. In addition, the communication control unit 201 receives the tag data transmitted from the wireless tag reading device 10.

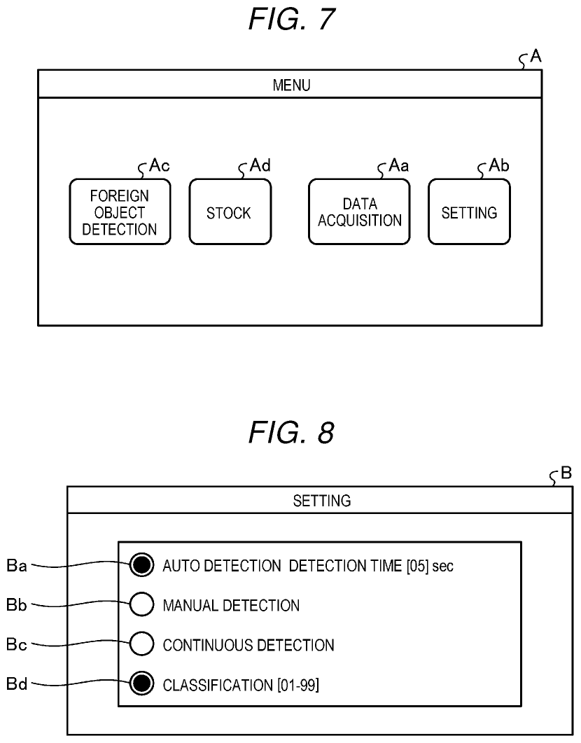

The display control unit 202 causes the display unit 25 to display various types of information. Specifically, the display control unit 202 causes the display unit 25 to display a GUI related to the operation of the wireless tag reading device 10. For example, the display control unit 202 causes the display unit 25 to display the GUI illustrated in FIG. 7.

FIG. 7 is a diagram illustrating an example of the GUI displayed on the display unit 25 of the mobile terminal 20. FIG. 7 illustrates an example of a menu screen. A menu screen A is an operation screen for selecting a task to be executed using the mobile terminal 20, and includes various operation buttons.

A data acquisition button Aa is an operation button for instructing to acquire (update) the equipment master. When the data acquisition button Aa is operated, the control unit 200 acquires the equipment master from the information processing device 30 connected to the own device in cooperation with the communication control unit 201, and performs data acquisition processing of storing the equipment master as the equipment master 241 into the storage unit 24.

A setting button Ab is an operation button operated when a setting related to the operation of the wireless tag reading device 10 is changed. A foreign object detection button Ac is an operation button for instructing to execute foreign object detection described later. A stock button Ad is an operation button for instructing to execute stock processing described later. When the operation buttons are operated, the display control unit 202 causes the display unit 25 to display GUIs for various tasks in cooperation with other functional configurations.

Referring back to FIG. 6, the operation control unit 203 receives an operation of the operator through the operation unit 26. For example, the operation control unit 203 receives an operation on the GUI displayed by the display control unit 202. In addition, the operation control unit 203 receives an operation on a hardware key such as the trigger button 171.

The reading operation control unit 204 instructs the operation of the wireless tag reading device 10 such as start of reading in response to an operation received from the operator. Specifically, the reading operation control unit 204 receives an operation of the operator through the operation button or the trigger button 171 displayed on the GUI. For example, when an operation of start of reading is received, the reading operation control unit 204 outputs instruction information for instructing to start the reading. In addition, for example, when an operation of end (stop) of reading is received, the reading operation control unit 204 outputs instruction information for instructing to end the reading.

The reading operation control unit 204 switches, based on the setting information on the reading operation, a reading time and enabling and disabling of the trigger button 171.

The setting change unit 205 instructs to change a setting on a reading operation of the wireless tag reading device 10 in response to an operation received from the operator. The setting change unit 205 receives the operation of the operator through, for example, the GUI illustrated in FIG. 8.

FIG. 8 is a diagram illustrating an example of the GUI displayed on the display unit 25 of the mobile terminal 20. FIG. 8 illustrates an example of a setting screen. The setting screen is displayed, for example, when the setting button Ab is operated in the menu screen A of FIG. 7.

As illustrated in FIG. 8, a setting screen B includes radio buttons Ba to Bd for performing various settings. Here, the radio buttons Ba to Bc are operation buttons for setting a time (hereinafter, also referred to as a detection time) related to reading of the wireless tag TG, and can be alternatively selected.

The radio button Ba is an operation button operated when the detection time is explicitly designated. By selecting the radio button Ba, the detection time can be set. FIG. 8 illustrates an example in which 5 seconds is set as the detection time. In this case, the setting change unit 205 stores the designated detection time as setting information. When the detection time is set, the reading operation control unit 204 outputs instruction information of the start of the reading in which the detection time is designated. In addition, the reading operation control unit 204 may continue to output the instruction information of the start of the reading during the set detection time.

The radio button Bb is an operation button (such as a start button Caa) displayed on the mobile terminal 20 or an operation button used when reading is performed using the trigger button 171. When the radio button Bb is selected, the setting change unit 205 stores, as the setting information, start and end of reading in conjunction with the operations of the operation button (the start button Caa or the like) and the trigger button 171 displayed on the mobile terminal 20. In this case, the setting change unit 205 outputs the instruction information of the start and end of the reading in response to the operations of the operation button (the start button Caa or the like) and the trigger button 171 displayed on the mobile terminal 20.

A radio button Bc is an operation button operated when the detection time is unlimited. When the radio button Bc is selected, the setting change unit 205 sets the detection time to unlimited. In this case, the reading of the wireless tag TG is continued until the stop of the reading is instructed by the operator.

The radio button Bd is an operation button operated when a classification of a reading target is designated. The operator can set the classification (classification code) of the reading target by selecting the radio button Bd. FIG. 8 illustrates an example in which classification codes 01 to 99 are set. The setting change unit 205 stores the set classification codes as the setting information. In this case, the reading result processing unit 206 extracts tag data (tag identifier) corresponding to a condition of the set classification codes from the tag data received by the communication control unit 201, and performs processing such as notification.

Referring back to FIG. 6, the reading result processing unit 206 acquires the tag data received by the communication control unit 201, and registers the tag data in the reading buffer 231 provided in the RAM 23. Here, every time the communication control unit 201 receives new tag data, the reading result processing unit 206 compares a tag identifier included in the tag data with a tag identifier of the tag data registered in the reading buffer 231. Then, when the tag identifiers are duplicated, the reading result processing unit 206 executes duplication check to discard the received tag data. Accordingly, the tag data including the same tag identifier can be prevented from being redundantly registered in the reading buffer 231.

The foreign object detection unit 207 is an example of a determination unit and a notification unit. The foreign object detection unit 207 detects, based on the equipment master 241, a foreign object mixed in the container P. Specifically, every time new tag data is registered in the reading buffer 231, the foreign object detection unit 207 collates the tag identifier of the tag data with a tag identifier registered in the equipment master 241, and determines whether the matching tag identifier is registered in the equipment master 241. In other words, the foreign object detection unit 207 collates a tag identifier registered in the reading buffer 231 with the tag identifier registered in the equipment master 241 to determine whether the wireless tag TG attached to the equipment F is read. If it is determined that the tag identifier is registered in the equipment master 241, that is, if it is determined that the wireless tag TG attached to the equipment F is read, the foreign object detection unit 207 determines that the foreign object is detected and performs a notification of the foreign object detection.

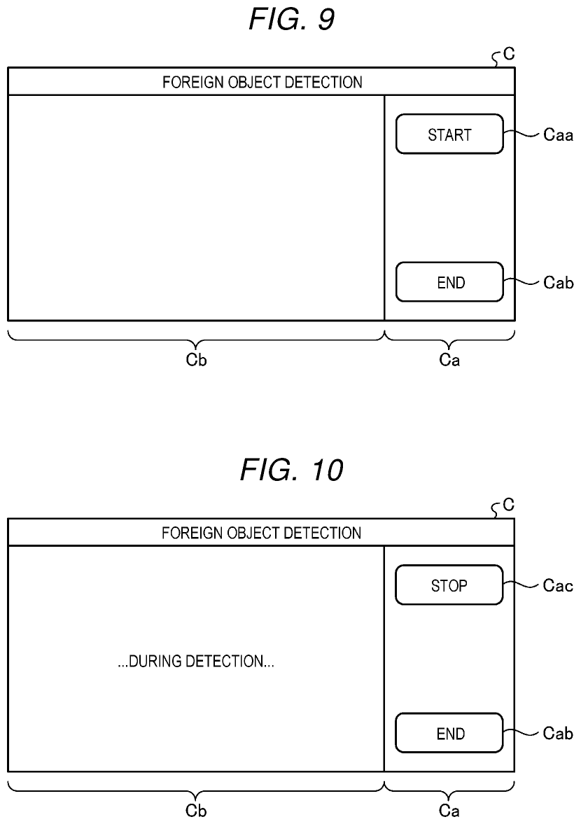

The foreign object detection unit 207 performs the above-described foreign object detection in response to the operation received from the operator. For example, when the foreign object detection button Ac is operated in the menu screen A of FIG. 7, the foreign object detection unit 207 displays a GUI related to the foreign object detection as illustrated in FIGS. 9 to 12 in cooperation with the display control unit 202.

FIGS. 9 to 12 are diagrams illustrating examples of the GUI displayed on the display unit 25 of the mobile terminal 20. FIGS. 9 to 12 illustrate examples of the foreign object detection screen.

As illustrated in FIG. 9, a foreign object detection screen C has a first region Ca and a second region Cb. Here, the second region Cb is a region for displaying an operation state and a reading result of the wireless tag reading device 10.

Various operation buttons are displayed in the first region Ca. For example, a start button Caa and an end button Cab are displayed in the first region Ca.

The start button Caa is an operation button for instructing to start the foreign object detection. When the operation of the start button Caa is received, the foreign object detection unit 207 outputs the instruction information for instructing to start the reading in cooperation with the reading operation control unit 204. When the reading is started by the operation of the start button Caa, as illustrated in FIG. 10, information indicating that a foreign object is being detected is displayed in the second region Cb.

The start button Caa is a toggle button that switches between start and stop of the foreign object detection every time an operation is received. When the start button Caa receives the operation, as illustrated in FIG. 10, the display is switched to a stop button Cac for instructing to stop the foreign object detection. When the operation of the stop button Cac is received, the foreign object detection unit 207 outputs instruction information for instructing to end the reading in cooperation with the reading operation control unit 204.

The end button Cab is an operation button for instructing to end the foreign object detection. When the operation of the end button Cab is received, the display control unit 202 ends the display of the foreign object detection screen C, and displays, for example, the menu screen A. If the end button Cab is operated during the reading operation, the foreign object detection unit 207 outputs instruction information for instructing to end the reading in cooperation with the reading operation control unit 204.

When the foreign object detection is started, the tag data read by the wireless tag reading device 10 is registered in the reading buffer 231 by the reading operation control unit 204 and the reading result processing unit 206. The foreign object detection unit 207 collates the tag identifier of the tag data read by the wireless tag reading device 10 with the equipment master 241 to determine whether the wireless tag TG attached to the equipment F is read. Here, if the tag identifier registered in the reading buffer 231 is registered in the equipment master 241, the foreign object detection unit 207 determines that the wireless tag TG attached to the equipment F is read, and notifies that the foreign object is detected.

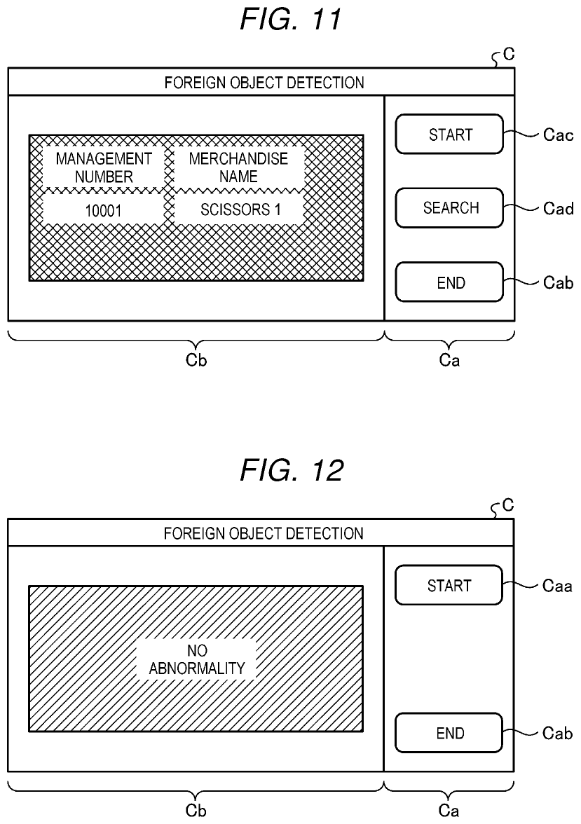

For example, the foreign object detection unit 207 reads the management number, the merchandise name, or the like of the equipment F associated with the corresponding tag identifier from the equipment master 241, and displays the read information in the second region Cb as illustrated in FIG. 11 to perform a notification of the foreign object detection.

FIG. 11 illustrates an example of the foreign object detection screen C if a foreign object is detected. As illustrated in FIG. 11, the foreign object detection unit 207 performs the notification by displaying, in the second region Cb, the management number and the merchandise name of the equipment F detected as the foreign object. In addition, the foreign object detection unit 207 displays a background color of the second region Cb in a warning color such as red in order to highlight and notify that the foreign object is detected. FIG. 11 illustrates an example in which a merchandise name “scissors 1” with a management number “10001” is detected as a foreign object.

Although FIG. 11 illustrates an example of a notification if one foreign object is detected, if a plurality of foreign objects are detected, the reading result processing unit 206 causes the display unit 25 to display a management number and a merchandise name for each of the detected foreign objects. In this case, the operator can select any one or the plurality of foreign objects displayed in the second region Cb as a processing target (hereinafter, also referred to as a search target) of search processing to be described later.

If the foreign object is detected, a search button Cad for instructing to search for the position of the container P, in which the foreign object is mixed, is displayed in the first region Ca. Processing when the search button Cad is operated will be described later.

If no foreign object is detected until the reading of the wireless tag reading device 10 ends, the foreign object detection unit 207 notifies that no foreign object is detected through the second region Cb as illustrated in FIG. 12.

Here, FIG. 12 illustrates the foreign object detection screen C in which no foreign object is detected. If no foreign object is detected, the foreign object detection unit 207 notifies that the foreign object is not present by displaying, in the second region Cb, a message such as no abnormality as illustrated in FIG. 12. In addition, the foreign object detection unit 207 displays the background color of the second region Cb in blue or the like different from that during the foreign object detection in order to highlight and notify that no foreign object is present.

Accordingly, the operator of the mobile terminal 20 can easily grasp, by directing the antenna 151 of the mobile terminal 20 to the container P, whether the foreign object is mixed. Accordingly, the mobile terminal 20 can efficiently detect the foreign object mixed in the container P.

A notification method of the presence or absence of a foreign object is not limited to screen display. For example, the reading result processing unit 206 may perform notification of the presence or absence of a foreign object by outputting a sound such as a beep sound from a sound output device (not illustrated) such as a speaker provided in the mobile terminal 20.

Referring back to FIG. 6, the search processing unit 208 is an example of a search unit. For the equipment F detected as a foreign object, the search processing unit 208 executes processing of searching the container P in which the equipment F is housed. For example, if the operation of the search button Cad (see FIG. 11) in the foreign object detection screen C described above is received, the search processing unit 208 executes the search processing based on a tag identifier of the detected foreign object.

Specifically, the search processing unit 208 outputs a reading start instruction in which a tag identifier of a foreign object which is a search target (hereinafter, also referred to as a tag identifier of a search target) is designated in cooperation with the reading operation control unit 204. Accordingly, the wireless tag reading device 10 selectively reads the tag data of the designated tag identifier and outputs the reading result to the mobile terminal 20.

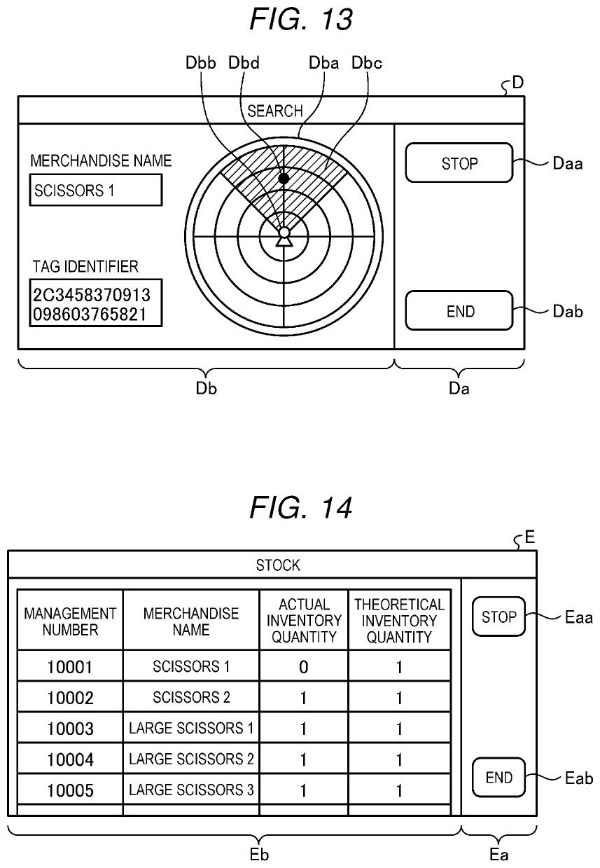

Next, the search processing unit 208 estimates, based on the reading result of the tag identifier of the search target, a presence position of the wireless tag TG holding the tag identifier, that is, a presence position of the equipment F detected as the foreign object. For example, the search processing unit 208 estimates a direction and a distance in which the wireless tag TG is present based on a reception state the tag data such as directivity of the antenna 151 and a received radio wave intensity of the communication control unit 201. Then, as illustrated in FIG. 13, the search processing unit 208 causes the display unit 25 to display a position corresponding to the direction and distance in which the wireless tag TG is present.

Here, FIG. 13 is a diagram illustrating an example of the GUI displayed on the display unit 25 of the mobile terminal 20. FIG. 13 illustrates an example of a search screen. The search screen is displayed, for example, when the search button Cad is operated in the foreign object detection screen C of FIG. 11.

As illustrated in FIG. 13, a search screen D includes a first region Da and a second region Db similarly to the foreign object detection screen C. An operation button Daa and an end button Dab are displayed in the first region Ca.

The operation button Daa is an operation button for instructing to start and stop the search processing. The operation button Daa is a toggle button that switches between the start and stop of the search processing every time an operation is received. The search processing unit 208 outputs instruction information for instructing to start or stop the reading in response to the operation of the operation button Daa in cooperation with the reading operation control unit 204.

FIG. 13 illustrates a state in which the search processing is being executed, and the expression of the operation button Daa is “stop” indicating that the search processing is stopped. When the operation button Daa is operated in this state, the reading operation control unit 204 outputs instruction information instructing to end the reading. In addition, when the operation button Daa is operated in the state of FIG. 13, the expression of the operation button Daa is switched to “start” or the like indicating that the search processing is started.

The end button Dab is an operation button for instructing to end the search processing. When the end button Dab is operated, the display control unit 202 ends the display of the search screen D and displays, for example, the foreign object detection screen C. When the end button Dab is operated at the middle of the search processing, the search processing unit 208 outputs instruction information for instructing to end the reading in cooperation with the reading operation control unit 204.

In the second region Db, the tag identifier of the search target and the merchandise name of the equipment F corresponding to the tag identifier are displayed. In addition, in the second region Db, a radar screen Dba indicating a direction and a distance in which the wireless tag TG corresponding to the tag identifier of the search target is present is displayed.

In the radar screen Dba, the position of the wireless tag reading device 10 is set as a center Dbb, and directions and distances are represented by concentric circles. In addition, in the radar screen Dba, a region Dbc indicated by a fan shape indicates a radiation range of the radio wave radiated by the wireless tag reading device 10.

When the equipment F which is a search target enters the radiation range and the tag data of the wireless tag TG attached to the equipment F is acquired by the communication control unit 201, the search processing unit 208 estimates the direction and the distance in which the wireless tag TG is present and displays an estimated position Dbd of the wireless tag TG in the region Dbc.

Accordingly, the operator can easily search for, by moving the position Dbd in the region Dbc and the center Dbb close to each other, the position in which the tag identifier of the search target is present, that is, the position of the container P into which the equipment F detected as a foreign object is mixed. As described above, according to the present embodiment, a search task of the container P in which the foreign object is mixed can be easily shifted from the detection of the foreign object.

Referring back to FIG. 6, the stock processing unit 209 is an example of a stock unit. The stock processing unit 209 performs stock processing of determining the presence or absence of each foreign object registered in the equipment master 241 based on the reading result of the wireless tag and the equipment master 241. Here, the stock processing is processing of confirming whether a respective one piece of the equipment F used at the distribution site has a predetermined number (hereinafter, also referred to as a theoretical inventory quantity) in a prescribed place (hereinafter, also referred to as an equipment management space). For example, the operator directs the antenna 151 of the mobile terminal 20 to the equipment management space, thereby reading the tag data from the equipment F which is a stock target.

Specifically, when the start of the stock processing is instructed by the operator, the stock processing unit 209 outputs a start instruction of the reading in cooperation with the reading operation control unit 204. In addition, the stock processing unit 209 clears the reading buffer 231 in cooperation with the reading result processing unit 206.

Next, the stock processing unit 209 totalizes the reading result of the tag data based on the equipment master 241. Specifically, the stock processing unit 209 totalizes the number of reading items of the equipment F corresponding to a respective one of the tag identifiers registered in the reading buffer 231. Here, the number of reading items may be totalized in units of individual merchandise (management number, merchandise name) or in units of classification. Then, the stock processing unit 209 outputs the totalized result as a stock result.

The stock processing unit 209 performs the above-described stock processing in response to an operation received from the operator. For example, when the stock button Ad is operated in the menu screen A of FIG. 7, the stock processing unit 209 displays a GUI related to the stock processing as illustrated in FIG. 14 in cooperation with the display control unit 202.

FIG. 14 is a diagram illustrating an example of the GUI displayed on the display unit 25 of the mobile terminal 20. FIG. 14 illustrates an example of a stock screen.

As illustrated in FIG. 14, a stock screen E includes a first region Ea and a second region Eb similarly to the foreign object detection screen C. An operation button Eaa and an end button Eab are displayed in the first region Ea.

The operation button Eaa is an operation button for instructing to start and stop the stock processing. The operation button Eaa is a toggle button that switches between the start and stop of the stock processing every time an operation is received. The stock processing unit 209 outputs instruction information for instructing to start or stop the reading in response to the operation of the operation button Eaa in cooperation with the reading operation control unit 204.

FIG. 14 illustrates a state in which the stock processing is being executed, and the expression of the operation button Eaa is “stop” indicating that the stock processing is stopped. When the operation button Eaa is operated in this state, the stock processing unit 209 outputs instruction information for instructing to end the reading. In addition, when the operation button Eaa is operated in the state of FIG. 14, the expression of the operation button Eaa is switched to “start” or the like indicating that the stock processing is started.

The end button Eab is an operation button for instructing to end the stock processing. When the end button Eab is operated, the display control unit 202 ends the display of the stock screen E and displays, for example, the menu screen A. When the end button Eab is operated at the middle of the stock processing, the stock processing unit 209 outputs instruction information for instructing to end the reading in cooperation with the reading operation control unit 204.

The result of the stock processing is displayed in the second region Eb. The second region Eb can be scrolled, for example, in an up-down direction, and can display, by a scroll operation, the result of the stock processing which is not displayed.

In FIG. 14, the stock result in units of individual merchandise is illustrated, and a theoretical inventory quantity and an actual inventory quantity are displayed in association with each other for each management number and merchandise name of the equipment F. Here, since the equipment F is represented in units of individual merchandise, the theoretical inventory quantity is “1”. In addition, the actual inventory quantity represents the number of reading items totalized by the stock processing unit 209, and is information indicating the presence or absence of the equipment F. All of the actual inventory quantities are “0” before the start of the stock processing.

For example, if all the pieces of equipment F are collected in the equipment management space, all of the actual inventory quantities are “1” in the result of the stock processing. In addition, for example, if some pieces of the equipment F are not present in the equipment management space due to mixing of some pieces of the equipment F into the container P, an actual inventory quantity of the absence equipment F is “0” in the result of the stock processing.

Accordingly, the operator can confirm whether all the pieces of equipment F are present in the equipment management space by confirming the stock result displayed in the second region Eb, and can easily grasp the pieces of equipment F which are absent. As described above, according to the present embodiment, the equipment F can be easily managed.

In the present embodiment, the stock result of the stock processing unit 209 is output to the display unit 25, and an output destination is not limited thereto. For example, the stock processing unit 209 may store the stock result in the storage unit 24 by outputting the stock result to the storage unit 24. In addition, the stock processing unit 209 may output the stock result to the information processing device 30.

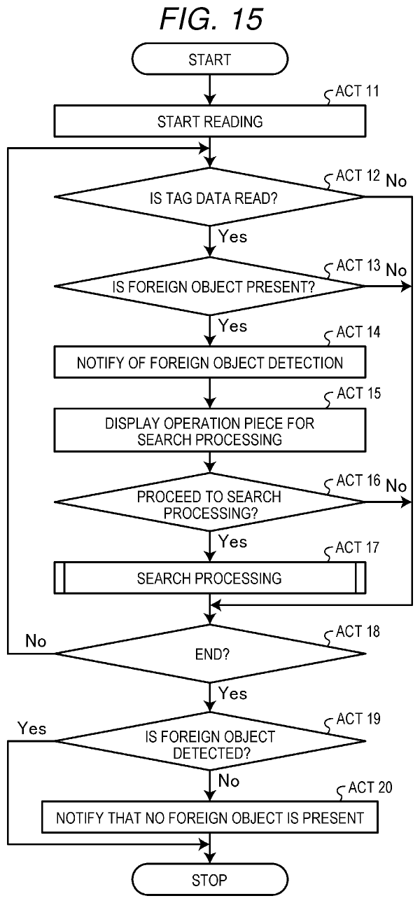

Hereinafter, an operation example of the mobile terminal 20 will be described with reference to FIGS. 15 to 17.

FIG. 15 is a flowchart illustrating an example of foreign object detection processing executed by the mobile terminal 20. First, when the start of the foreign object detection is instructed by the operator through the operation or the like of the start button Caa (see FIG. 9) in the foreign object detection screen C, the foreign object detection unit 207 instructs the wireless tag reading device 10 to start the reading in cooperation with the reading operation control unit 204 (ACT 11).

Subsequently, the foreign object detection unit 207 determines whether the tag data is read by the wireless tag reading device 10 (ACT 12). Specifically, the foreign object detection unit 207 determines whether new tag data is registered in the reading buffer 231 by monitoring the reading buffer 231. If the tag data is not read (ACT 12; No), the processing proceeds to ACT 18.

If the foreign object detection unit 207 determines that the tag data is read in ACT 12 (ACT 12; Yes), the processing proceeds to ACT 13. In ACT 13, the foreign object detection unit 207 collates the tag identifier included in the tag data read in ACT 12 with the tag identifier registered in the equipment master 241 to determine whether the tag identifier indicates a foreign object (equipment F) (ACT 13).

Here, if the tag identifier of the tag data read in ACT 12 is not registered in the equipment master 241, the foreign object detection unit 207 determines that no foreign object is detected (ACT 13; No), and the processing proceeds to ACT 17. If the tag identifier of the tag data read in ACT 12 is registered in the equipment master 241, the foreign object detection unit 207 determines that the foreign object is detected (ACT 13; Yes), and the processing proceeds to ACT 14.

In ACT 14, the foreign object detection unit 207 reads the management number, the merchandise name, or the like of the detected foreign object from the equipment master 241 and causes the display unit 25 to display the management number, the merchandise name, or the like, thereby notifying that the foreign object is detected (ACT 14). In addition, the foreign object detection unit 207 causes the display unit 25 to display the operation button (search button Cad) capable of instructing the transition to the search processing (ACT 15).

Subsequently, the foreign object detection unit 207 determines whether the transition to the search processing is instructed (ACT 16). Here, if the transition to the search processing is instructed (ACT 16; Yes), the search processing unit 208 executes the search processing (ACT 17). In addition, if the transition to the search processing is not instructed (ACT 16; No), the processing proceeds to ACT 18.

Subsequently, the foreign object detection unit 207 determines whether the end of the foreign object detection is instructed (ACT 18). Here, the instruction to end the foreign object detection is not limited to the operation by the operator, and is a concept including the end of reading due to the timeout of the detection time.

If the instruction to end the foreign object detection is not given (ACT 18; No), the foreign object detection unit 207 returns the processing to ACT 12 to continue the foreign object detection. In addition, if the instruction to end the foreign object detection is given (ACT 18; Yes), the foreign object detection unit 207 determines whether the foreign object is detected in the foreign object detection (ACT 19).

Here, if it is determined that no foreign object is detected (ACT 19; No), the foreign object detection unit 207 notifies that the foreign object is not present by causing the display unit 25 to display a message such as “no abnormality” (ACT 20), and then ends the processing. In addition, if it is determined that the foreign object is detected (ACT 19; Yes), the foreign object detection unit 207 ends the present processing while leaving the notification of the foreign object displayed in ACT 14 and ACT 15 and the search button.

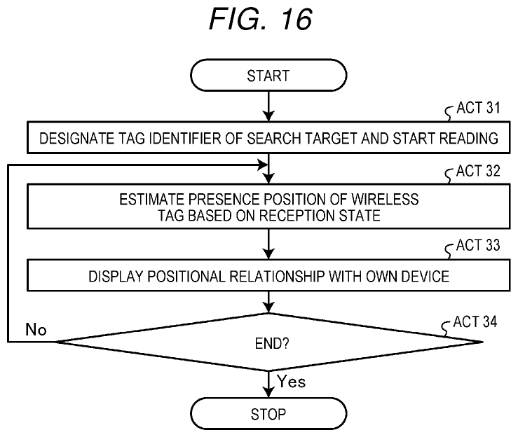

FIG. 16 is a flowchart illustrating an example of the search processing executed by the mobile terminal 20. The present processing is performed, for example, in response to the operation of the search button Cad (see FIG. 11) displayed on the foreign object detection screen C. In addition, the present processing also corresponds to, for example, the search processing performed in ACT 17 of FIG. 15.

First, the search processing unit 208 instruct the wireless tag reading device 10 to start the reading in which the tag identifier of the search target is designated (ACT 31) in cooperation with the reading operation control unit 204.

Subsequently, the search processing unit 208 estimates the presence position of the wireless tag TG holding the tag identifier based on the reception state of the radio wave related to the reading of the tag identifier of the search target (ACT 32). Next, the search processing unit 208 causes the display unit 25 to display a relative positional relationship between the estimated presence position and a presence position of the own device using the radar screen Dba or the like illustrated in FIG. 13 (ACT 33).

Subsequently, the search processing unit 208 determines whether the end of the search processing is instructed (ACT 34). Here, the instruction to end the search processing is not limited to the operation by the operator, and is a concept including the end of reading due to the timeout of the detection time. The search processing unit 208 may set the detection time to be unlimited while performing the search processing.

If the end of the search processing is not instructed (ACT 34; No), the search processing unit 208 returns the processing to ACT 32 to continue the search processing. If the end of the search processing is instructed (ACT 34; Yes), the search processing unit 208 ends the present processing.

If the execution of the present processing is started from ACT 17 of FIG. 15, the search processing unit 208 may return the processing to ACT 18 after the search processing is ended. In addition, in this case, the search processing unit 208 may return the processing to ACT 18 after clearing the reading buffer 231.

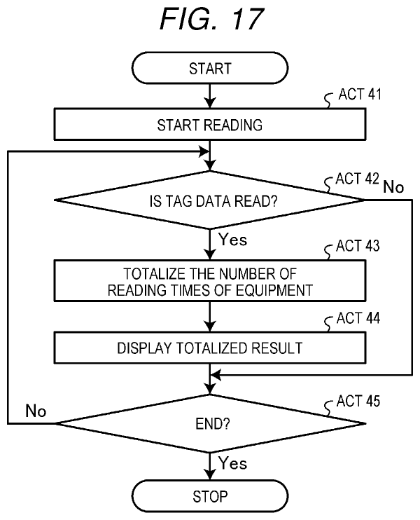

FIG. 17 is a flowchart illustrating an example of the stock processing executed by the mobile terminal 20. First, when the start of the stock processing is instructed by the operator through the operation or the like of the operation button Eaa (see FIG. 14) in the stock screen E, the stock processing unit 209 instructs the wireless tag reading device 10 to start the reading in cooperation with the reading operation control unit 204 (ACT 41).

Subsequently, the stock processing unit 209 determines whether the tag data is read by the wireless tag reading device 10 (ACT 42). If the tag data is not read (ACT 42; No), the processing proceeds to ACT 45.

If it is determined that the tag data is read in ACT 42 (ACT 42; Yes), the stock processing unit 209 totalizes, based on the equipment master 241, the number of reading items of the equipment F corresponding to a respective one of the tag identifiers included in the tag data (ACT 43). Next, the stock processing unit 209 causes the display unit 25 to display the totalized result (ACT 44), and the processing proceeds to ACT 45.

Subsequently, the stock processing unit 209 determines whether the end of the stock processing is instructed (ACT 45). Here, the instruction to end the stock processing is an instruction to end the reading by an operation of the operator. The instruction to end the stock processing is not limited to the operation by the operator, and may be a concept including the end of reading due to the timeout of the detection time.

If the end of the stock processing is not instructed (ACT 45; No), the stock processing unit 209 returns the processing to ACT 42 to continue the stock processing. If the end of the search processing is instructed (ACT 45; Yes), the stock processing unit 209 ends the present processing.

As described above, the mobile terminal 20 according to the present embodiment determines, based on the reading result of the wireless tag TG obtained by the wireless tag reading device 10 radiating the radio wave for reading the wireless tag for the container P housing the article G and the equipment master 241 in which the tag identifier held by the wireless tag TG attached to the equipment F is registered, whether the wireless tag TG attached to the equipment F is read. If it is determined that the wireless tag TG attached to the equipment F is read, the mobile terminal 20 notifies that the foreign object is detected. In addition, if no foreign object is detected at a time point when the reading operation on the wireless tag is ended, the mobile terminal 20 notifies that no foreign object is present.

Accordingly, the operator of the mobile terminal 20 can easily grasp whether the equipment F is mixed in the container P by directing the radio wave of the wireless tag reading device 10 to the container P. Accordingly, according to the mobile terminal 20 of the present embodiment, a foreign object mixed in the container P can be efficiently detected.

If a foreign object is detected, the mobile terminal 20 searches for a position in which the foreign object is present based on the reception state of the radio wave related to the reading of the wireless tag attached to the foreign object, and causes the display unit 25 to display the searched position.

Accordingly, the operator of the mobile terminal 20 can specify the position of the container P in which the foreign object is mixed. Accordingly, according to the mobile terminal 20 of the present embodiment, a foreign object mixed in the container P can be efficiently detected.

The mobile terminal 20 determines, based on the reading result of the wireless tag by the wireless tag reading device 10 and the equipment master 241, the presence or absence of each piece of the equipment F registered in the equipment master 241, and causes the display unit 25 to display the determination result.

Accordingly, for example, the operator of the mobile terminal 20 can easily grasp the presence or absence of each piece of the equipment F used at the distribution site by directing the radio wave of the wireless tag reading device 10 to the equipment management space. Accordingly, according to the mobile terminal 20 of the present embodiment, a foreign object mixed in the container P can be efficiently detected.

As described above, according to the foreign object detection system 1 of the present embodiment, a foreign object mixed in the container P can be efficiently detected.

The above-described embodiment can be appropriately modified and implemented by changing a part of the configuration or function of each of the above-described devices. Hereinafter, some modifications according to the above-described embodiment will be described as other embodiments. Hereinafter, points different from the above-described embodiment will be mainly described, and detailed description of points common to the already described contents will be omitted. In addition, the modifications described below may be implemented individually or may be implemented in combination as appropriate.

### Modification 1

In the above-described embodiment, the configuration is described in which the wireless tag TG is attached to the equipment F which is a foreign object and the read tag data is collated with the equipment master 241 to detect the foreign object. However, the wireless tag TG is not limited to be attached to the equipment F, and may be attached to the article G.

For example, at a distribution site, the wireless tag TG is attached to a respective one of the articles G which are distribution targets and the container P that houses the corresponding article G, so that the wireless tag TG may be used for article management such as delivery management and inventory management. In such a case, for example, an article management data file (hereinafter, also referred to as an article management master) in which information (hereinafter, article information) on the article G and the container P is registered is prepared in association with tag identification of the wireless tag TG attached to the article G and the container P, and is stored in the storage unit 24 of the mobile terminal 20. Then, the mobile terminal 20 may detect a foreign object by collating the tag data read through the wireless tag reading device 10 with the equipment master 241, and perform article management by collating the tag data with the article management master.

For example, if a tag identifier of the tag data read by the wireless tag reading device 10 matches a tag identifier registered in the article management master, the foreign object detection unit 207 reads article information associated with the tag identifier from the article management master. Then, the foreign object detection unit 207 may cause the display unit 25 to display the read article information. If a foreign object is detected during reading of the wireless tag TG related to the article management, the foreign object detection unit 207 notifies that the foreign object is detected, by causing the display unit 25 to display a management number and a merchandise name of the detected foreign object together with the article information.

For example, the stock processing unit 209 may execute stock processing related to the article management of the article G and the container P based on the article management master. In this case, the foreign object detection unit 207 may perform foreign object detection based on the equipment master 241 in the background of the stock processing related to the article management by the stock processing unit 209. In this case, if the foreign object is detected, the foreign object detection unit 207 also notifies that the foreign object is detected, by causing the display unit 25 to display the management number and the merchandise name of the detected foreign object.

Accordingly, the mobile terminal 20 according to the modification can perform the article management on the article G and the container P, and can achieve the same effect as that of the above-described embodiment.

### Modification 2

In the above-described embodiment described, the wireless tag reading device 10 is a handy type wireless tag reading device, but the wireless tag reading device 10 is not limited to this form. For example, the wireless tag reading device 10 may be a gate type wireless tag reading device. In this case, the wireless tag reading device 10 reads the wireless tag TG by radiating a radio wave to the container P passing through a gate. Accordingly, the mobile terminal 20 can detect a foreign object based on tag data read by the gate type wireless tag reading device 10.

The gate type wireless tag reading device 10 and the handy type wireless tag reading device 10 may be used in combination. In this case, for example, the mobile terminal 20 is first connected to the gate type wireless tag reading device 10. Next, if a foreign object is detected in the gate type wireless tag reading device 10, the mobile terminal 20 is connected to the handy type wireless tag reading device 10 while holding a tag identifier of the foreign object. Then, the operator of the mobile terminal 20 can search for the container P in which the foreign object is mixed from among a plurality of containers P passing through the gate by performing search processing using the handy type wireless tag reading device 10.

### Modification 3

In the above-described embodiment, the mobile terminal 20 performs foreign object detection and search processing and stock processing. If an other device other than the mobile terminal 20 includes the functional configurations of the mobile terminal 20 illustrated in FIG. 6, the other device may perform the foreign object detection and search processing and the stock processing.

For example, the information processing device 30 may perform the search processing and the stock processing by including a part or all of the functional configurations of the mobile terminal 20.

### Modification 4

In the above embodiment, the example of the setting screen (see FIG. 8) related to the operation of the wireless tag reading device 10 is described, but settable contents are not limited thereto.

For example, output (transmission output) of a radio wave radiated from the wireless tag reading device 10 may be settable. For example, a Q value related to an anti-collision function, which defines the maximum number of wireless tags to be read in one time of processing, may be settable. In addition, for example, a session ID (S0 to S3) for designating a state holding method of an inventory flag (A, B) of the wireless tag may be settable.

For example, if the wireless tag reading device 10 has a configuration (for example, a code scanner or the like) capable of reading a code symbol such as a bar code, a reading target may be settable to only the wireless tag or both the wireless tag and the code symbol. If the reading target is set to only the wireless tag, the wireless tag reading device 10 disables a reading function of the code symbol in response to an instruction from the setting change unit 205.

The programs executed by the devices of the above-described embodiments are provided in a state of being incorporated in advance in a ROM, a storage unit, or the like. The programs executed by the devices of the above-described embodiments may be provided by being recorded in a computer-readable recording medium such as a CD-ROM, a flexible disk (FD), a CD-R, or a digital versatile disk (DVD) in a file in an installable or executable format.

Furthermore, the programs executed by the devices of the above-described embodiments may be provided by being stored in a computer connected to a network such as the Internet and being downloaded via the network. The programs executed by the devices of the above-described embodiments may be provided or distributed via a network such as the Internet.

While embodiments have been described, the embodiments have been presented by way of example and are not intended to limit the scope of the exemplary embodiments. These novel embodiments and the modifications thereof can be implemented in various other forms, and various omissions, replacements, and modifications can be made without departing from the gist of the disclosure. The embodiments and the modifications thereof are included in the scope and the gist of the exemplary embodiments, and are included in a scope of the exemplary embodiments disclosed in the claims and equivalents thereof.

What is claimed is:

1. A foreign object detection device, comprising:
a determination component configured to determine, based on a reading result of a wireless tag obtained by radiating a radio wave for reading the wireless tag for a container housing an article and a data file in which a tag identifier held by a wireless tag attached to a foreign object different from the article is registered, whether the wireless tag attached to the foreign object is read; and
a notification component configured to notify that the foreign object is detected if it is determined that the wireless tag attached to the foreign object is read.

2. The foreign object detection device according to claim 1, further comprising:
a search component configured to search for, based on a reception state of the radio wave related to the reading of the wireless tag, a position in which a foreign object is present if it is determined that the wireless tag attached to the foreign object is read, and cause a display component to display the searched position.

3. The foreign object detection device according to claim 1, further comprising:
a stock component configured to determine, based on the reading result of the wireless tag and the data file, presence or absence of each foreign object registered in the data file, and cause a display component to display a determination result.

4. The foreign object detection device according to claim 1, wherein
the notification component is configured to notify that a foreign object is not present when the wireless tag attached to the foreign object is not read at a time point when a reading operation on the wireless tag is ended.

5. The foreign object detection device according to claim 1, further comprising:
a reading component configured to radiate the radio wave for reading the wireless tag and read the tag identifier from the wireless tag responding to the radio wave, wherein
the determination component is configured to determine, based on the reading result of the reading component and the data file, whether the wireless tag attached to the foreign object is read.

6. The foreign object detection device according to claim 1, wherein the foreign object detection device is smartphone or a tablet terminal.

7. The foreign object detection device according to claim 1, further comprising an information processing device configured to generate and manage a data file for foreign object detection.

8. The foreign object detection device according to claim 5, wherein the reading component is further configured to read tag data from the wireless tag in a communication region of an antenna on an instruction from a mobile terminal.

9. The foreign object detection device according to claim 8, further comprising a communication controller configured to transmit tag data read by the reading component to the mobile terminal.

10. The foreign object detection device according to claim 9, wherein the communication controller is further configured to receive various types of information transmitted from the mobile terminal.

11. A foreign object detection method, comprising:
determining, based on a reading result of a wireless tag obtained by radiating a radio wave for reading the wireless tag for a container housing an article and a data file in which a tag identifier held by a wireless tag attached to a foreign object different from the article is registered, whether the wireless tag attached to the foreign object is read; and
performing notification if it is determined that the wireless tag attached to the foreign object is read.

12. The foreign object detection method according to claim 11, further comprising:
searching for, based on a reception state of the radio wave related to the reading of the wireless tag, a position in which a foreign object is present if it is determined that the wireless tag attached to the foreign object is read, and causing a display component to display the searched position.

13. The foreign object detection method according to claim 11, further comprising:
determining, based on the reading result of the wireless tag and the data file, presence or absence of each foreign object registered in the data file, and causing a display component to display a determination result.

14. The foreign object detection method according to claim 11, further comprising:
notifying that a foreign object is not present when the wireless tag attached to the foreign object is not read at a time point when a reading operation on the wireless tag is ended.

15. The foreign object detection method according to claim 11, further comprising:
radiating the radio wave for reading the wireless tag and read the tag identifier from the wireless tag responding to the radio wave; and
determining, based on the reading result of reading and the data file, whether the wireless tag attached to the foreign object is read.

16. The foreign object detection method according to claim 11, wherein the foreign object detection device is smartphone or a tablet terminal.

17. The foreign object detection method according to claim 11, further comprising generating and managing a data file for foreign object detection.

18. The foreign object detection method according to claim 15, further comprising:
reading tag data from the wireless tag in a communication region of an antenna on an instruction from a mobile terminal.

19. The foreign object detection method according to claim 18, further comprising transmitting tag data read by the reading to the mobile terminal.

20. The foreign object detection method according to claim 19, further comprising:
receiving various types of information transmitted from the mobile terminal.
